(19) United States
(12) Patent Application Publication
(10) Pub. No.: US 2005/0244022 A1
(43) Pub. Date: Nov. 3, 2005

(54) Hearing aid compatible device

(75) Inventors: Sivakumar Muthuswamy, Plantation, FL (US); Anupama Ramamurthy, Plantation, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/833,627

(22) Filed: Apr. 28, 2004

(51) Int. Cl. H04R 25/00; H04M 1/00; H04M 9/00

(52) U.S. Cl. 381/315; 381/316; 379/430; 381/330

(57) ABSTRACT

A removable bezel (122) for use with an audio device (120) to enhance operation with a hearing aid (102). The removable bezel (122) has an electromagnetic coil (132) that is coupled to the audio output (124, 304, 404, 406) of the audio device. The electromagnetic coil (132) is either inductively coupled to an acoustic transducer (124) within the audio device (120) or by a direct electrical connection (314). The electromagnetic coil (132) has multiple turns and provides an enhanced magnetic field to a “T-Coil” magnetic pick up (112) within most conventional hearing aids (102). A cellular phone (104) is an example of an audio device used with the present invention. A method for use of the removable bezel (122) is also provided.

### FIELD OF THE INVENTION

The present invention generally relates to the field of communications devices for the hearing impaired and more particularly to communications devices adapted to interact with hearing aids.

### BACKGROUND OF THE INVENTION

Persons with hearing impairments have a variety of available devices to assist in augmenting their impaired hearing abilities. A common device used by persons with hearing impairments is the in-ear hearing aid device. In-ear hearing aid devices are compact audio amplifiers that detect sound energy, amplify the sound and produce an amplified sound signal into the ear of the wearer.

Many in-ear hearing aids provide an electromagnetic pick-up coil, referred to as a “tele-coil” or “T-coil,” that is designed to be used with conventional telephone handsets. The sensitivity of these T-coils is designed for use with the relatively large speaker structure of conventional telephone handsets. As a result, T-coil operation is generally ineffective when using the much smaller and lower current ear-piece speakers found in portable electronic devices, such as cell phones. As an accommodation, cellular phone can be operated with a “neck loop” accessory, which is a loop worn around a user's neck and connected to a cell phone's audio output in order to generate an electromagnetic field that is coupled to the T-coil of the hearing aid. Neck loops have several disadvantages, including their bulk, inconvenience, and aesthetic issues. Another problem with using neck loops is present with users who have a hearing aid in each ear. Such users often have different hearing aid sensitivity for each ear. The electromagnetic field generated by a neck loop couples equally to each ear, and can result in a hearing difference between the two ears that is inconvenient or even bothersome to the user. Therefore a need exists to overcome the problems with the prior art as discussed above.

### SUMMARY OF THE INVENTION

According to an embodiment of the present invention, a removable bezel for enhancing inductive coupling to a hearing aid worn by a user has a back side adapted to attach to an electronic device having an acoustic transducer and a front side. The removable bezel further has a multiple turn electromagnetic coil disposed in proximity to one of the front side and the back side the front side and the back side and positioned to inductively couple to the acoustic transducer and the multiple turn electromagnetic coil positioned to inductively couple to a hearing aid worn by a user when located alongside a face of the user.

In a further aspect of the present invention, an audio device for enhancing inductive coupling to a hearing aid worn by a user has an enclosure, an audio processor for producing an analog audio output signal, a removable bezel adapted to attach to the enclosure, and a multiple turn electromagnetic coil. The multiple turn electromagnetic coil is coupled to the audio processor and disposed in proximity to the removable bezel. The multiple turn electromagnetic coil is positioned to inductively couple to a hearing aid worn by a user when located alongside a face of the user.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a side view of a hearing aid coupling system operational environment 100 according to an exemplary embodiment of the present invention.

FIG. 2 illustrates cellular phone front view according to the exemplary embodiment illustrated in FIG. 1.

FIG. 3 illustrates a first alternative removable bezel configuration according to an alternative embodiment of the present invention.

FIG. 4 illustrates a second alternative removable bezel configuration according to another alternative embodiment of the present invention.

FIG. 5 is an electronic schematic diagram illustrating an exemplary cell phone according to an exemplary embodiment of the present invention.

FIG. 6 is a processing flow diagram for coupling electromagnetic energy between an audio device and a hearing aid according to an exemplary embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

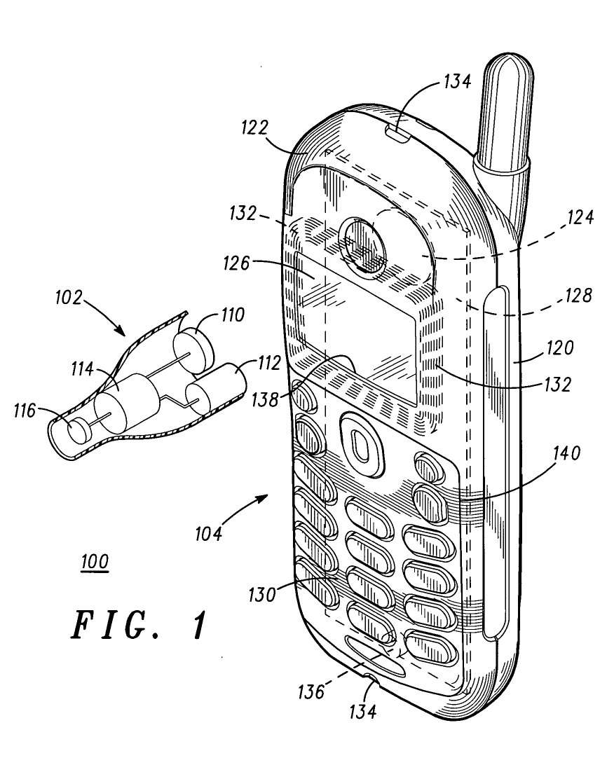

FIG. 1 illustrates a side view of a hearing aid coupling system operational environment 100 according to an exemplary embodiment of the present invention. The hearing aid coupling system operational environment 100 includes a hearing aid 102 and a cellular telephone 104 that has a hearing aid coupling system according to an exemplary embodiment of the present invention. In this operational environment, hearing aid 102 is inserted into a user's ear (not shown) and cellular telephone 104 is positioned alongside the user's face with the top of the phone near the user's ear, as in conventional usage by non-hearing impaired users.

Hearing aid 102 includes an acoustic pickup 110, which is similar to a miniature microphone. Hearing aid 102 further includes an electromagnetic pickup 112, which is often referred to as a T-coil. Hearing aid 102 includes electronic processor 114, which includes signal processing circuitry that accepts input signals from the acoustic pickup 110 and the electromagnetic pickup 112. Signals received from the acoustic pickup 110 and the electromagnetic pickup 112 are conditioned, which is able to include frequency selective amplification, and provided to speaker 116. As is known by ordinary practitioners in the relevant arts, hearing aid 102 has dimensions and is adapted to be inserted in a user's ear. Speaker 116 provides amplified audio signals into the user's ear in order to facilitate hearing by a hearing impaired user.

Cellular telephone 104 has an electronic device that is a conventional cell phone body 120. Cell phone body 120 in this exemplary embodiment includes the components of ordinary cellular telephones. Cell phone body 120 includes an acoustic transducer, which is speaker 124 in this embodiment, a display 126, a keyboard 130, a microphone 136, and a printed circuit board (PCB) 128. Acoustic speaker 124 is an electromagnetic speaker that is optimized to minimize current. Acoustic speaker 124 of the exemplary embodiment contains an internal electromagnetic coil that is used to move a diaphragm and generate sound. The small size of the acoustic speaker limits the size of this internal electromagnetic coil and this small size, along with the low current driving the coil, causes the acoustic speaker 124 to generate a relatively small electromagnetic field outside of the cell phone body 120. In normal operation, the acoustic speaker 120 of conventional cell phones does not produce a sufficiently strong electromagnetic field to adequately drive the electromagnetic pick up T-coil 112 of hearing aid 102.

Cellular phone 104 further includes a removable bezel 122. The removable bezel has a front side and a back side that is opposite the front side. The back side of the removable bezel 122 is adapted to attach to the cell phone body 120 and is physically secured to the cell phone body 120 by connection points 134. This exemplary embodiment has two connection points 134, one on the top and one on the bottom of the cell phone 120. Connection points 134 in the exemplary embodiment allow easy physical disconnection and reconnection of the removable bezel 122 from the cell phone body 120.

The removable bezel 122 includes an electromagnetic coil 132. Electromagnetic coil 132 of this exemplary embodiment is a multi-turn coil formed of a conductive material, such as copper or aluminum. The ends of the electromagnetic coil 132 of this embodiment are connected together, so as to form a continuous, multiple turn loop. Electromagnetic coil 132 in this exemplary embodiment is formed so as to extend along three sides of the front of the removable bezel 122, as is discussed below. The electromagnetic coil 132 of the exemplary embodiment is disposed in proximity to the removable bezel 122 by being located within the removable bezel 122. Further embodiments have an electromagnetic coil 132 located in proximity to the removable bezel 122 by, for example, being affixed within the front or back of removable bezel 122 or on the outside of the removable bezel. The electromagnetic coil 132 is located within close proximity to the acoustic speaker 124 when the removable bezel is attached to the cell phone body 120 and supports strong coupling of magnetic fields between the acoustic speaker 124 and the electromagnetic coil 132. The strong magnetic coupling between the electromagnetic coil 132 and the acoustic speaker 124 results in a strong current being induced in the electromagnetic coil 132. The current induced in the electromagnetic coil 132 is conducted around the multiple turn, continuous electromagnetic coil 132 and thereby generates an increased electromagnetic field in the area of the electromagnetic coil 132. This increased electromagnetic field induces a greater current in the electromagnetic pickup 112 of hearing aid 102 when the cellular phone 104 is in proximity to hearing aid 102. Embodiments of the present invention adapt the multiple turn electromagnetic coil 132, and the entire removable bezel, to particular hearing aid designs so that effective and possibly optimized coupling to the electromagnetic pick up 112 of particular hearing aid designs is possible.

Removable bezel 122 further has a display opening 138 and keyboard opening 140. The display opening 138 and keyboard opening 140 are openings disposed in the front of the removable bezel 122 to allow visual access to see the user display 126 and access the keyboard 130.

Removable bezel 122 advantageously allows a hearing impaired user to add or remove the fixture to provide increased coupling to his or her hearing aid 102 as needed. The removable bezel 122 can be removed, for example, if a non-hearing impaired user is using the cellular phone 104. Different bezels that are useable with a particular model of cell phone body 120 are also able to be customized for different hearing aids and or other features.

Further embodiments of the present invention allow a user to configure the circuits of the cell phone body 120 to drive the acoustic speaker with increased drive current. This induces additional current into the multiple turn electromagnetic coil 132 and provides induction of stronger signals in the T-coil 112 within the hearing aid.

Other embodiments of the present invention incorporate acoustic transducers that are located at different locations within an electronic device. Various embodiments of the present invention also include multiple acoustic transducers, such as acoustic transducer for an earpiece and a separate acoustic transducer for use as a speakerphone. These embodiments of the present invention operate by inducing current in the electromagnetic coil 132, or in equivalent structures, from one or more of the acoustic transducers located in the cellular phone.

FIG. 2 illustrates a cellular phone front view 200 according to the exemplary embodiment discussed above. As discussed above, the removable bezel 122 has a display opening 138 and a keyboard opening 140. The cellular phone front view 200 demonstrates the visibility of display 126 through the display opening 138 as well as the access to the keyboard 130 through though keyboard opening 140. Microphone 136 is also shown as exposed through the keyboard opening 140, thereby allowing efficient operation of the microphone 136 in picking up voice sounds from a user holding the cellular phone 104 alongside his or her face.

The electromagnetic coil 132 is shown as encircling the display opening 138 in this embodiment. The electromagnetic coil 132 is shown to have a relatively square or rectangular cross section and is formed along three outer edges of the removable bezel 122. This configuration allows a large cross-sectional area for the electromagnetic coil. The location of acoustic speaker 124 is shown as near the top portion of the electromagnetic coil 132. The ends of the electromagnetic coil 132 are joined at junction 202 so as to form a continuous loop that carries currents induced from the acoustic speaker 124.

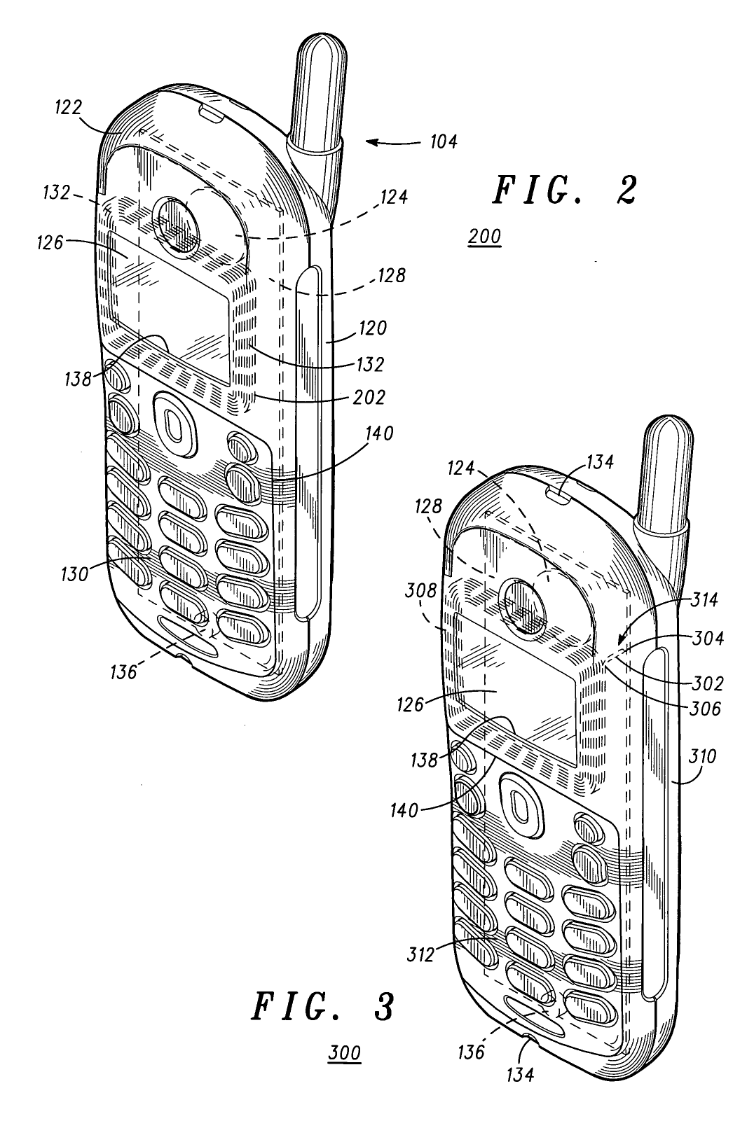

FIG. 3 illustrates a first alternative removable bezel configuration 300 according to an alternative embodiment of the present invention. The cell phone body 310 of this first alternative embodiment is similar to the cell phone body 120 of the above exemplary embodiment and has a direct electrical/physical connection 314. The direct electrical/physical connection 314 is a conductive connection that provides a direct electrical connection between the PCB 128 and the first alternative electromagnetic coil 308. The direct electrical connection 314 of this first alternative embodiment includes a two conductor link 302 that provides a direct balanced current drive to the first alternative electromagnetic coil 308. The two conductor link 302 connects to electrical circuits on the PCB 128 and at a PCB connection 304. The two conductor link 302 further connects to a coil connector 306 that is in electrical contact with the two ends of the conductor forming the first alternative electromagnetic coil 308. Various embodiments of the first alternative bezel configuration include direct electrical/physical connections 314 that allow disconnection at either the PBC connection 304, the coil connector 306, or in the middle of the two conductor link 302. This allows the first alternative removable bezel 312 to be removed from the first alternative cell phone body 310. The first alternative removable bezel 312 is also secured to the first alternative cell phone body by physical connections 134.

FIG. 4 illustrates a second alternative removable bezel configuration 400 according to another alternative embodiment of the present invention. The second alternative removable bezel configuration 400 is similar to the first alternative removable bezel configuration discussed above, except a direct electrical connection between the second alternative cell phone body and the second alternative electromagnetic coil 432 is provided by alternative connections. The second alternative electromagnetic coil 432 has a direct electrical connection to the second alternative cell phone body 420 that is provided through either an earplug jack 404 or an accessory connector 406. The second alternative electromagnetic coil 432 has an alternative two conductor link 412 that extends from the second alternative electromagnetic coil 432 to a connector 402 that is located at the bottom of the second alternative removable bezel 422. Connector 402 is able to be connected to an earplug adapter 412 that connects to an earplug jack 404. Embodiments allow an earplug adapter 412 that is able to connect to an external headset jack instead of an earplug jack 404. Connector 402 is alternatively able to be connected to an accessory connector adapter 410 that plugs into an accessory connector 406 that is part of the second alternative cell phone body 420. Accessory connector 406 is a conventional accessory connector that is present on many cellular phones that allows connection to power, audio, RF, and processor control signals that are internal to the cell phone body 420. It is clear that the connector 402 is only required to be connected to one of the accessory connector adapter 410 and the earplug adapter 412. Connection to both is illustrated in FIG. 4 of this disclosure for brevity of description. Some embodiments of the present invention determine that a direct electrical connection is established to the electromagnetic coil of the bezel and then cease to drive internal acoustic speakers within the electronic device. Such operation can be realized, for example, through a mechanical switch that is part of the earplug adapter 412 that operates to disconnect the drive from internal speakers when a connector 402 is inserted therein. This allows electronic devices incorporating the present invention to operate without acoustic output to improve privacy and reduce inconvenience or disturbance to others who are nearby. This operation also serves to conserve current consumed by the device since the acoustic speaker is not powered when it is unnecessary. Yet further embodiments of the present invention detect the insertion of a removable bezel, such as removable bezel 422, and cease to drive, such as by disconnecting, internal speakers. These embodiments detect the insertion of the removable bezel 422 through a number of methods, such as electrical contacts at the attachment points for the removable bezel 422, magnetic proximity switches, RFID, and other methods known to ordinary practitioners in the relevant arts.

It is clear that embodiments of the present invention are able to be used in a variety of applications. For example, a removable bezel incorporating embodiments of the present invention are able to be used with “flip-phones” that have two portions connected by a hinge. A bezel that is adapted for use on a flip-phone can attach to the flip-phone once the phone is opened, or can be adapted to attach in a way that allows the flip-phone to close while the bezel is attached, such as by being attached to the back of one portion of the flip-phone portion.

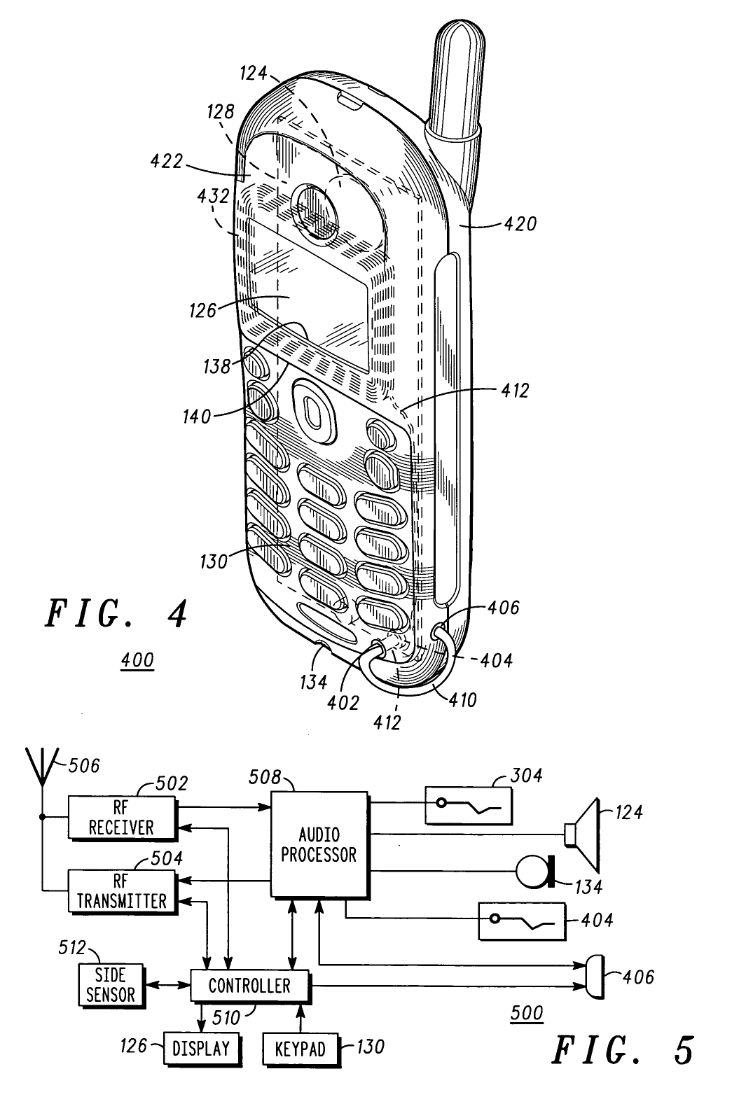

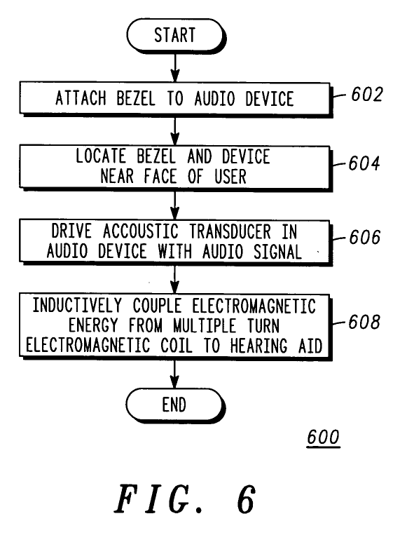

FIG. 5 illustrates an exemplary cell phone body electronic schematic diagram 500. The electronic schematic diagram 500 includes an RF receiver 503 for receiving RF signals and producing detected audio and/or data output. Detected signals are provided to audio processor 508 for required processing and preparation for output to acoustic speaker 124 and/or direct connections to the electromagnetic loop, such as through PCB connector 304, earplug connector 404 and accessory connector 406. Some embodiments of the present invention cease to drive the acoustic speaker 124, or other acoustic transducer, when a direct connection is made to an electromagnetic loop.

The exemplary cell phone body electronic schematic diagram 500 also includes an RF transmitter 504 that is used to produce and modulate an RF signal for transmission from the cell phone body 120. The RF transmitter 504 transmits voice signals produced by audio processor 508 based upon audio signals that are picked up and electrically produced by the microphone 134. The RF transmitter 504 and the RF receiver 502 use a common RF antenna 506 in the exemplary embodiment. The common RF antenna 506 may be shared through RF sharing and/or switching means, in a manner well known to those of ordinary skill in the art, to allow both transmit and receive wireless communications over one or more communication channels.

Some embodiments of the present invention include a side sensor 512, which is a mechanism that makes a determination of whether the user is using the cellular phone 104 on his or her left ear or right ear. Such embodiments are able to be configured to cause the audio processor 508 to adjust its output level in response to the determination of which ear the user is using. Such a configuration is useful in the event that the user has different hearing sensitivities in each ear. The exemplary electronic schematic diagram 500 illustrates a side sensor 512. Side sensor 512 is able to include any such sensors as are known by ordinary practitioners in the relevant arts. An example of such a side sensor is a tilt sensor that determines if the cellular phone 104 is tilted one way or another and in such a way that would indicate which ear the user is using.

Controller 510 of the exemplary embodiment includes a programmable processor (and/or controller) that normally includes a computer readable medium that contains programming instructions required to control the communications station. The control circuits 602 also receive input from the keyboard 130. Controller 510 further provides and monitor signals provided through the accessory connector 406.

FIG. 6 illustrates a processing flow diagram 600 for a method of providing an electromagnetic coupling between an audio device and a hearing aid. The processing begins by attaching, at step 602, a removable bezel to an audio device. In the exemplary embodiment, the audio device comprises an acoustic transducer and the removable bezel comprises a multiple turn electromagnetic coil that is positioned to inductively couple to the acoustic transducer. The use of the exemplary embodiment then locates, at step 604, the removable bezel near a face, and/or the person, of a user. The exemplary embodiment further drives, at step 606, the acoustic transducer with an audio signal. The exemplary embodiment then inductively couples, at step 608, electromagnetic energy from the multiple turn electromagnetic coil to a hearing aid of, and/or typically worn by, the user.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The terms “between” and “among” are not to be interpreted as limiting, the use of “between” alone is not to be interpreted as a term of limitation that restricts an action to only two objects, and the use of “among” alone is not to be interpreted as a term of limitation that excludes an action from operating upon only two objects.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

1. A bezel for enhancing inductive coupling to a hearing aid worn by a user, the bezel comprising:
a back side adapted to attach to an electronic device having an acoustic transducer;
a front side; and
a multiple turn electromagnetic coil disposed in proximity to one of the front side and the back side, and positioned to inductively couple to the acoustic transducer and the multiple turn electromagnetic coil positioned to inductively couple to a hearing aid worn by a user when located alongside a face of the user.

2. The bezel according to claim 1, further comprising at least one of a display opening and a keyboard opening, the display opening disposed to allow visual access to a display of the electronic device and the keyboard opening disposed to allow access to a keyboard of the electronic device.

3. The bezel according to claim 1, wherein the multiple turn electromagnetic coil is designed to provide effective coupling to a particular hearing aid design.

4. The bezel according to claim 1, further comprising a cell phone body containing the acoustic transducer, the cell phone body configurable to have an increased current drive to the acoustic transducer so as to induce increased current in the multiple turn electromagnetic coil.

5. A removable bezel for enhancing inductive coupling to a hearing aid worn by a user, the removable bezel comprising:
a back side adapted to attach to an electronic device;
a front side;
a direct electrical connection adapted to connect to an electrical audio signal produced by the electronic device; and
a multiple turn electromagnetic coil, electrically connected to the direct electrical connection, disposed in proximity to one of the front side and the back side, the multiple turn electromagnetic coil positioned to inductively couple to a hearing aid worn by a user when located alongside a face of the user.

6. The removable bezel according to claim 5, wherein the direct electrical connection comprises at least one of a printed circuit board connection, an earplug connection, an external headset connection and an accessory connection.

7. The removable bezel according to claim 5, further comprising at least one of a display opening and a keyboard opening, the display opening disposed to allow visual access to a display of the electronic device and the keyboard opening disposed to allow access to a keyboard of the electronic device.

8. An audio device for enhancing inductive coupling to a hearing aid worn by a user, the audio device comprising:
an enclosure;
an audio processor for producing an analog audio output signal;
a removable bezel adapted to attach to the enclosure; and
a multiple turn electromagnetic coil coupled to the audio processor and disposed in proximity to the removable bezel, the multiple turn electromagnetic coil positioned to inductively couple to a hearing aid worn by a user when located alongside a face of the user.

9. The audio device according to claim 8, further comprising an RF receiver, wherein the audio device comprises a cellular telephone.

10. The audio device according to claim 8, wherein the enclosure further comprises at least one of a display and a keyboard and wherein the removable bezel further comprises at least one opening to allow access to at least one of the display and the keyboard.

11. The audio device according to claim 8, further comprising a side sensor that makes a determination of whether the enclosure is placed on a left ear or a right ear of the user, and wherein the audio processor is communicatively coupled to the side sensor and the audio processor adjusts an output level in response to the determination.

12. The audio device according to claim 8, wherein the multiple turn electromagnetic coil is coupled to the audio processor by a conductive connection.

13. The audio device according to claim 12, wherein the conductive connection is a direct electrical connection that comprises at least one of a printed circuit board connection, an earplug connection, an external headset connection and an accessory connection.

14. A method of providing an electromagnetic coupling between an audio device and a hearing aid, the method comprising:
attaching a removable bezel to an audio device, the audio device comprising an acoustic transducer, the removable bezel comprising a multiple turn electromagnetic coil that is positioned to inductively couple to the acoustic transducer;
locating the removable bezel near a user;
driving the acoustic transducer with an audio signal; and
inductively coupling electromagnetic energy from the multiple turn electromagnetic coil of the removable bezel to a hearing aid worn by the user.

15. The method of claim 14, wherein the locating comprises locating the removable bezel near the face of a user.

16. The method of claim 14, wherein the locating comprises locating the removable bezel near the face of a user, and wherein the inductively coupling electromagnetic energy comprises inductively coupling electromagnetic energy from the multiple turn electromagnetic coil of the removable bezel to a hearing aid worn in an ear of the user.
